(19) United States
(12) Patent Application Publication
(10) Pub. No.: US 2009/0110883 A1
(43) Pub. Date: Apr. 30, 2009

(54) LAMINATES HAVING PRINTED EXTERIOR SURFACE FOR USE AS CONSTRUCTION MATERIALS

(76) Inventor: Bryan HUGHES, Kelowna (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 12/257,281

(22) Filed: Oct. 23, 2008

Related U.S. Application Data
(60) Provisional application No. 60/982,355, filed on Oct. 24, 2007.

(51) Int. Cl. B32B 5/00; B32B 5/02; B32B 38/14; B32B 38/06

(52) U.S. Cl. 428/141; 428/195.1; 428/196; 428/201; 156/277; 156/220

(57) ABSTRACT

This application relates to printed laminates for use in decking, roofing or other construction applications. In one embodiment, the laminates comprises a flexible substrate interposed between inner an outer membranes. The outer membrane may be formed, for example, from polyvinylchloride (PVC). The exterior surface of the outer membrane is printed in a gravure printing process to simulate the appearance of a building material, such as aggregate, stone, shakes, shingles, tile or marble. Multiple layers of ink may be applied to the exterior surface in predetermined pattern to simulate a three-dimensional appearance of the building material. The exterior surface may also be embossed to enhance the visual simulation.

### RELATED APPLICATION

This application claims the benefit of the filing date of U.S. provisional patent application No. 60/982,355 filed 24 Oct. 2007, the entirety of which is hereby incorporated by reference.

### TECHNICAL FIELD

This application relates to printed laminates for use in decking, roofing or other construction applications.

### BACKGROUND

Laminates for use as flooring, decking and roofing materials are well-known in the prior art. For example, some laminates consist of one or more layers of polyvinyl chloride (PVC) membrane applied to a scrim composed of fabric threads. A filler material composed of non-woven fabric or foam may be added below the scrim to increase laminate thickness. Typical laminates comprising reinforced PVC membranes used for decking applications are approximately 60 mil in thickness.

Conventional vinyl laminates used as building materials have an exposed, exterior surface which is typically smooth and untextured. While such laminates are useful for many applications, they are not capable of realistically simulating the three-dimensional look of many building materials, such as aggregate, stone, shakes, shingles, tiles or marble.

The need has therefore arisen for improved laminates having a printed and/or embossed exterior surface for simulating the appearance of building materials.

### SUMMARY OF INVENTION

In accordance with the invention, a laminate is provided comprising a flexible substrate; and an outer membrane having a first surface and a second surface, wherein said first surface is bonded to said substrate and second surface is printed to simulate the appearance of a building material.

The invention also relates to a method of forming a laminate simulating the appearance of a building material comprising providing an outer membrane having a first surface and a second surface; printing the second surface to simulate the appearance of the building material; providing a flexible substrate; and laminating the first surface to the substrate.

### BRIEF DESCRIPTION OF DRAWINGS

In drawings which describe embodiments of the invention but which should not be construed as restricting the spirit or scope thereof,

FIG. 1 is a side perspective, partially exploded view of a laminate formed in accordance with invention.

FIG. 2 is a top perspective, partially exploded view of a laminate formed in accordance with the invention

FIGS. 3A-3C illustrate three separate color separations used for printing a film for simulating the appearance of aggregate.

### DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

This application relates to a flexible laminate 10 suitable for use as construction material. For example, laminate 10 may be used as a decking or roofing covering. Laminate 10 is designed to simulate the appearance of a conventional building material, such as aggregate, stone, shakes, shingles, tile or marble. As discussed below, many other visual effects may also be simulated.

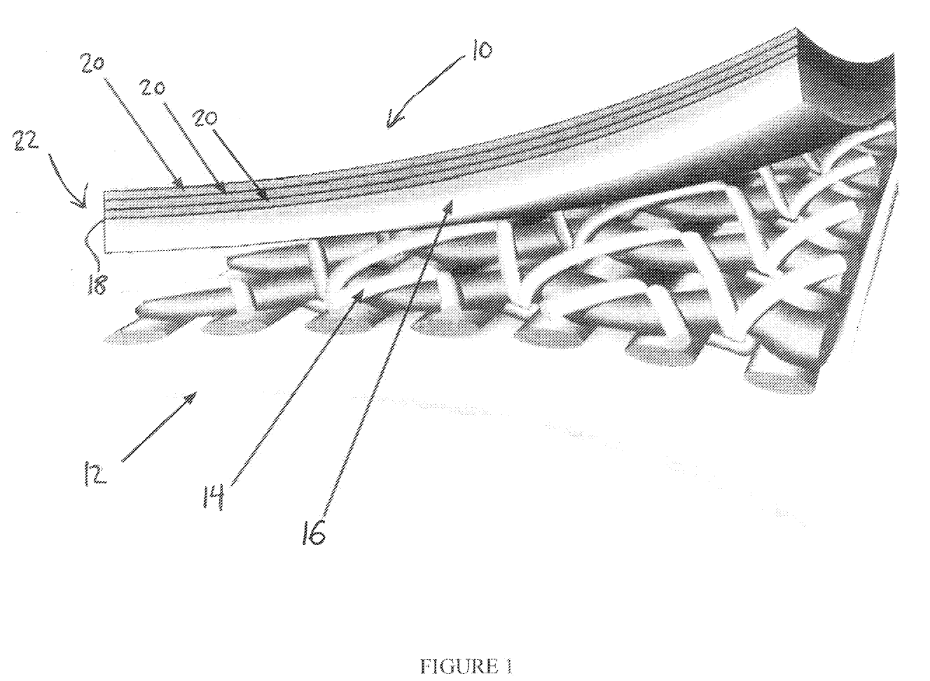

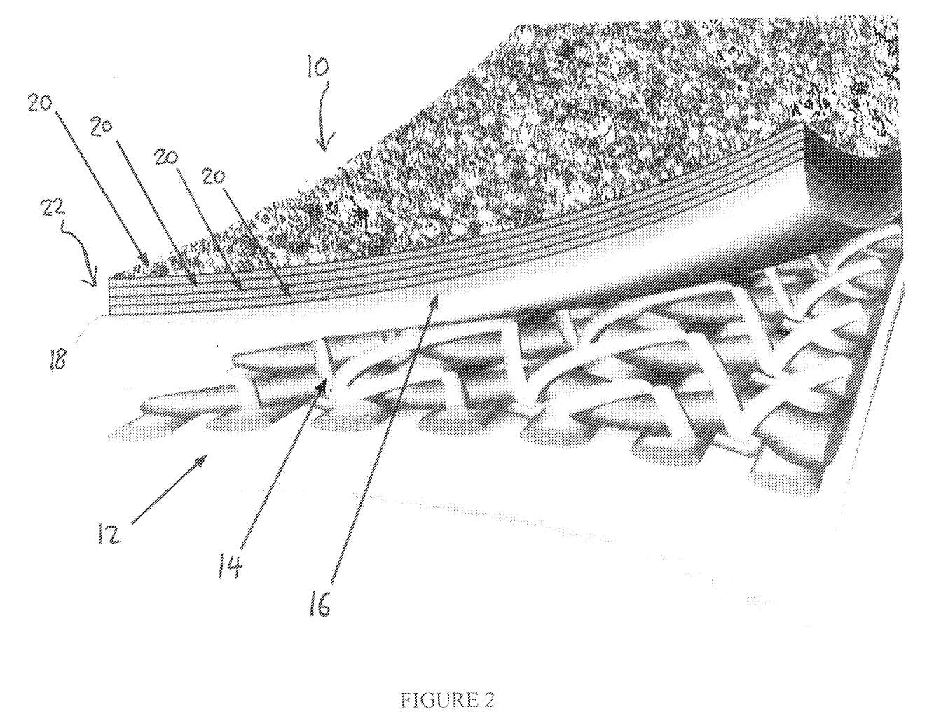

As shown in FIGS. 1 and 2, laminate 10 includes an inner membrane 12, a scrim 14 and an outer membrane 16. Outer membrane 16 is preferably printed and embossed to form a printed membrane 22 simulating the appearance of a conventional building product. In the illustrated embodiment, membranes 12 and 16 are each formed from a layer of polyvinylchloride (PVC) film which is bonded to the scrim 14. Scrim 14 thus provides reinforced support for membranes 12, 16 and is formed from a fabric comprised of low wick polyester yarns. By way of non-limiting example, scrim 14 may consist of a weft-insertion scrim.

Laminate 10 is formed in a multi-stage manufacturing process as described below. As will be appreciated by a person skilled in the art, many variations are possible without departing from the invention.

### Calendering Film Production

The first step in the process is to calender flexible PVC films to produce membranes 12, 16. The PVC resin is mixed with various liquids to impart flexibility, heat stability, weatherability, color, and resistance to antimicrobial attack. As will be appreciated by a person skilled in the art, ingredients are added to the mixer at a prescribed temperature and time to ensure proper dispersion and adsorption onto the PVC surface. The resulting dry blend is in the form of a coarse and granular powder.

The dry blend is next conveyed to a high shear mixer which applies heat and friction to the powder particles. This compounding process converts the powder into a fused mass.

The fused compound is conveyed to a 4 roll inverted-L calender which has 3 nip points. As the compound passes through each successive nip point, it is converted into a film. When the film releases from the last calender roll, it is stretched to the final thickness and cooled by a series of pick off rolls, tempering rolls, and cooling rolls.

The calendered film is trimmed at each edge to the final width and wound up on a fiberboard core to the desired put up or length.

For decking or roofing applications, membranes 12, 16 formed from the calendered films may have a thickness ranging from about 0.003″-0.030″. In one particularly preferred embodiment, the membrane thickness may vary from about 0.021″ to 0.028″. In one embodiment, membrane 16 may be somewhat thicker than membrane 12 (e.g. 0.028″ and 0.0213″).

As will be appreciated by a person skilled in the art, membranes 12, 16 may be alternatively formed by other well-known processes. For, example, membranes 12, 16 may be extruded rather than calendered.

### Printing Process

An important feature of the present invention is that a custom print pattern is applied to the exterior facing surface 18 of membrane 16 to simulate the appearance of a building material, such as such as aggregate, stone, shakes, shingles, tiles or marble. This may be achieved by applying multiple print layers 20 to the calendered film using gravure printing equipment. According to the gravure print process, a series of cylinders are used to successively print a different colored ink onto the film substrate. The process can be adapted to simulate the appearance of a conventional building material by modifying the process as follows:

1. A digital photo of the desired pattern is rendered into a computer aided drawing (CAD) program
2. The CAD program is interfaced with an etching machine that cuts a pattern into the print roll.
3. When the process is complete, a total of 3 print rolls contain an identical pattern. This is important because any variance in the pattern between rolls will cause print registration defects.
4. Each print roll is installed into the print line.
5. Each print roll has a pan that is located underneath the roll. This pan is used to introduce a custom matched ink color. This will allow the present invention to contain three distinct colors within the print pattern and develop a “three-dimensional” look which simulates the look of the building material. For example, the process can be used to simulate the appearance of aggregate, stone, shakes, “3 tab” shingles, cedar shingles, scalloped shingles, ceramic tiles, marble or any other desired building material by modifying the design on the print cylinder.

As shown schematically in FIGS. 1 and 2, multiple print layers 20 are applied to outer membrane 16 to form a printed membrane 22. Optionally, a clear coating may be applied to prevent adherence between the ink and rollers. After print layers 20 have been applied, the printed membrane 22 may then be embossed to impart surface texture as described further below. FIG. 2 shows an exemplary printed membrane 22 which has been printed and embossed simulate the appearance of aggregate.

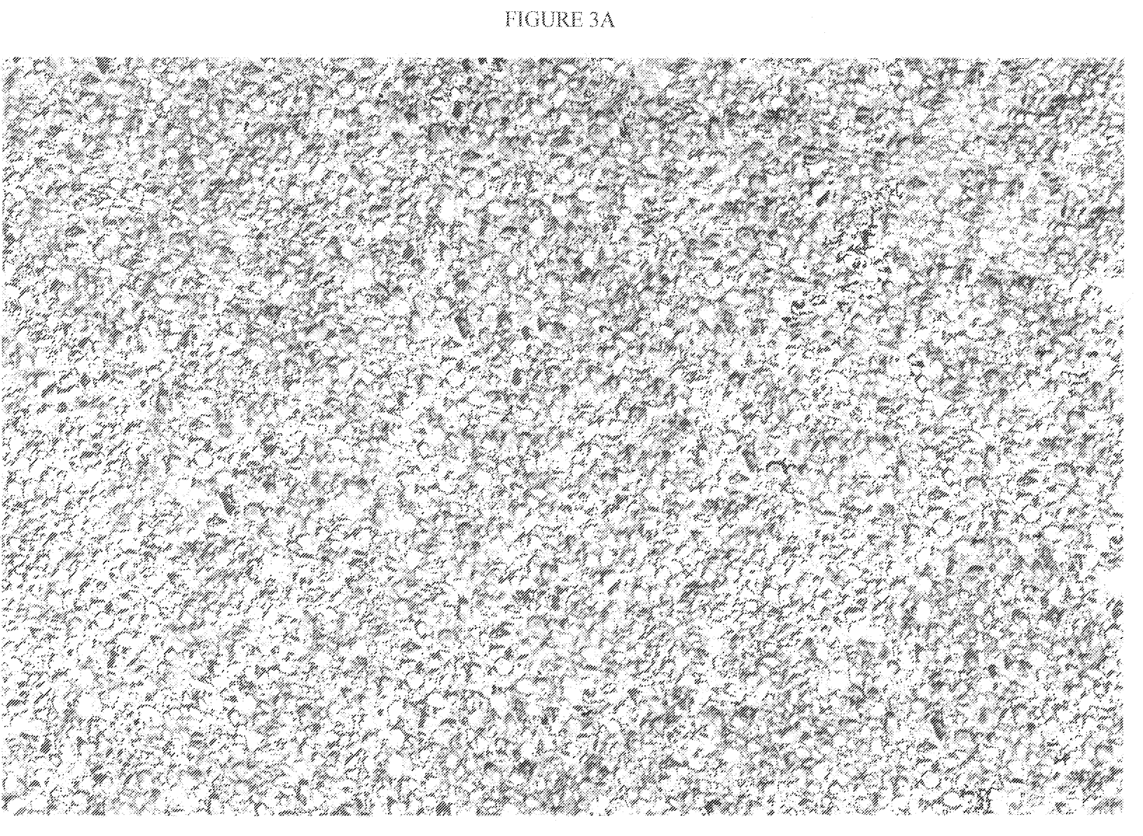

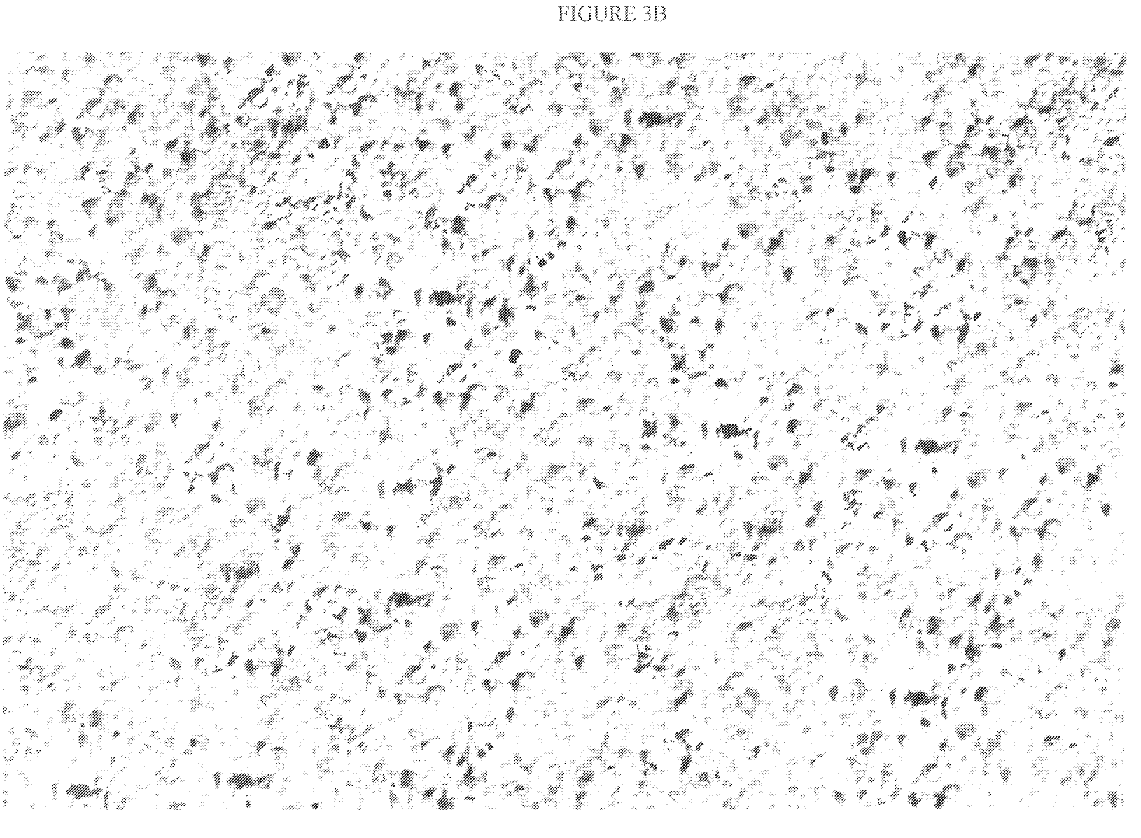

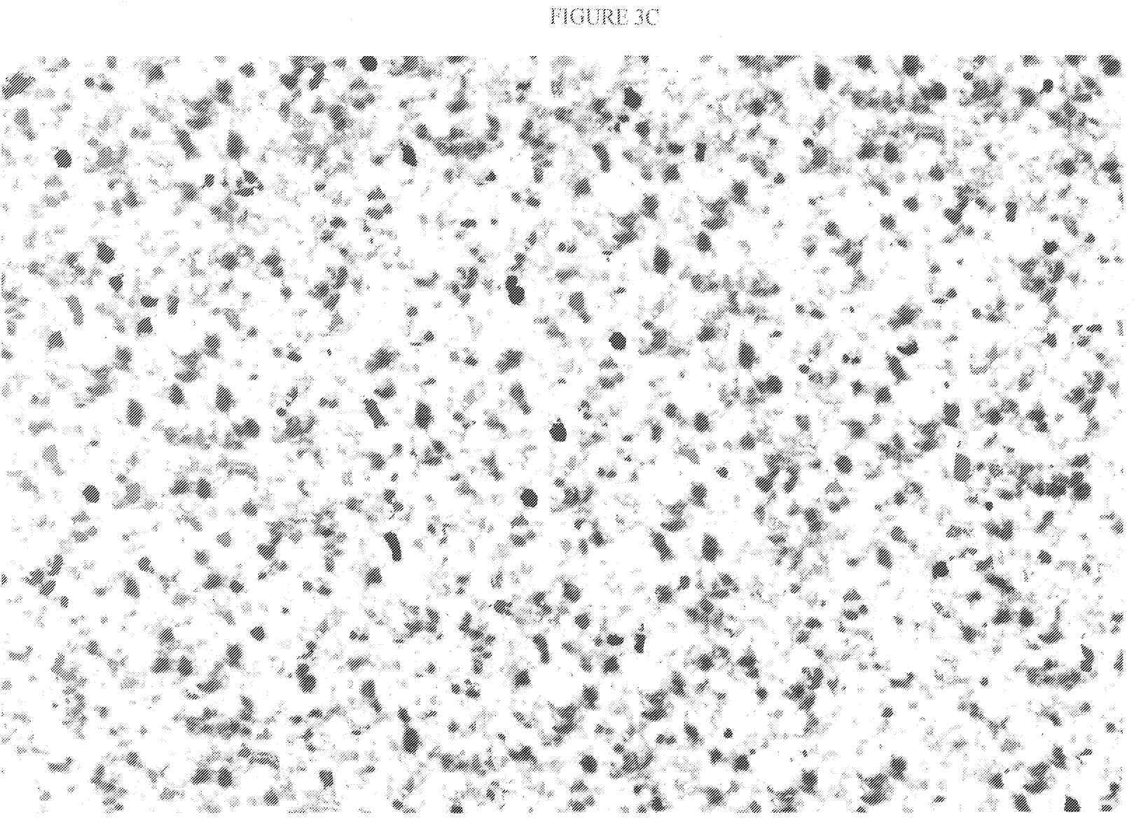

FIGS. 3A-3C illustrate three color separations used for printing a film for simulating the appearance of aggregate. Depending upon the simulation desired, additional color separations could also be employed.

As will be appreciated by a person skilled in the art, the printing process may be applied to membranes 16 of many different thicknesses. For example, in some embodiments the thickness of membrane 16 may vary between about 20 to 60 mil.

The interior membrane 12 is ordinarily not printed as it is not visible once installed.

### Scrim Production

The next step is to manufacture a fabric comprised of low wick polyester yarns. Alternatively, the fabric can be produced with wicking polyester yarns. Eighteen 840 denier yarns per inch in the warp direction and fourteen 1000 denier yarns per inch in the weft direction are tied together with a 70 denier tie yarn using a weft insert knitting machine. The particular make-up and size of the scrim may vary without departing from the invention.

### Laminating and Embossing

The laminating process uses a plastisol adhesive, heat, and pressure to melt bond membrane printed membrane 22 to scrim 14. In this process, printed membrane 22 is coated with a plastisol adhesive and applied to one side of scrim 14 and passed over 3 infrared heaters and 2 press rollers to embed the film into the scrim. Membrane 12 may also be applied to scrim 14 in a similar manner, thereby forming laminate 10.

Laminate 10 is then heated further and fed through a taffeta emboss roll to emboss printed membrane 22. The texture of the emboss controls the gloss, imparts shadows on the printed surface and reflects ambient light which adds depth to the product.

The laminate 10 is cooled and wound up into finished product. The final product is particularly adapted for use as a decking or roofing material because it utilizes a building and construction pattern that is aesthetically pleasing and implements a layer construction that is needed to meet regulatory requirements, such as Canadian CGSB 37.54, UL 790, ULC-S107 and ASTM D4434 requirements. The product could also be adapted for use as an exterior wall covering, fascia, soffit, waterproofing membrane. As will be appreciated by a person skilled in the art, the same printing process may be applied to other substrates, such as semi-rigid polyvinylchloride (PVC), PVC/acrylonitrile-butadiene rubber (NBR) alloys, ketone ethylene ester (KEE) polymer, KEE/flexible PVC alloys. This printing process may be applied to other substrates by changing the solvent and ink carrier. Additional substrates may include polyethylene, polypropylene, thermoplastic vulcanizates, thermoplastic olefin's or thermoplastic elastomers.

The laminates of the invention have the advantages of vinyl coverings, such as waterpoofness, ultraviolet protection, cost, and ease of installation while providing the visual effect of more costly and anesthetically pleasing building materials.

As will be apparent to those skilled in the art in the light of the foregoing disclosure, many alterations and modifications are possible in the practice of this invention without departing from the spirit or scope thereof. Accordingly, the scope of the invention is to be construed in accordance with the invention defined by the following claims.

What is claimed is:

1. A laminate comprising:
(a) a flexible substrate;
(b) an outer membrane having a first surface and a second surface, wherein said first surface is bonded to said substrate and second surface is printed to simulate the appearance of a building material.

2. The laminate as defined in claim 1, wherein said second surface is embossed to simulate the texture of said building material.

3. The laminate as defined in claim 2, further comprising an inner membrane bonded to said substrate, wherein said substrate is interposed between said inner and outer membranes.

4. The laminate as defined in claim 1, wherein said second surface comprises a plurality of print layers.

5. The laminate as defined in claim 1, wherein said building material is selected from the group consisting of aggregate, stones, shakes, shingles, tiles and marble.

6. The laminate as defined in claim 5, wherein said building material is aggregate.

7. The laminate as defined in claim 4, wherein said print layers comprise different colors.

8. The laminate as defined in claim 1, wherein said outer membrane is formed from a material selected from the group consisting of polyvinylchloride (PVC), polyethylene, polypropylene, thermoplastic vulcanizates, thermoplastic olefin's or thermoplastic elastomers.

9. The laminate as defined in claim 1, wherein said outer membrane comprises polyvinylchloride (PVC) polymer.

10. The laminate as defined in claim 1, wherein said outer membrane is selected from the group consisting of semi-rigid polyvinylchloride (PVC), PVC/acrylonitrile-butadiene rubber (NBR) alloys, ketone ethylene ester (KEE) polymer and KEE flexible PVC alloys.

11. The laminate as defined in claim 1, wherein said substrate comprises polyester yarns.

12. The laminate as defined in claim 11, wherein said polyester yarns are low wick polyester yarns.

13. The laminate as defined in claim 8, wherein said inner membrane is formed from a material selected from the group consisting of polyvinylchloride (PVC), polyethylene, polypropylene, thermoplastic vulcanizates, thermoplastic olefin's or thermoplastic elastomers.

14. The laminate as defined in claim 1, wherein said outer membrane has a thickness within the range of about 0.003″-0.030″.

15. The laminate as defined in claim 14, wherein said outer membrane is approximately 0.028″ in thickness.

16. The laminate as defined in claim 3, wherein said laminate is approximately 60 mil in thickness.

17. The laminate as defined in claim 1, wherein said second surface comprises a plurality of print layers, each of said layers having a predetermined pattern and a different color for simulating said building material.

18. The laminate as defined in claim 17, wherein said print layers create a three-dimensional visual effect.

19. The laminate as defined in claim 18, wherein said print layers are emboss-sed.

20. A method of forming a laminate simulating the appearance of a building material comprising:
(a) providing an outer membrane having a first surface and a second surface;
(b) printing said second surface to simulate the appearance of said building material;
(c) providing a flexible substrate; and
(d) laminating said first surface to said substrate.

21. The method as defined in claim 20, further comprising embossing said second surface after said laminating.

22. The method as defined in claim 20, comprising providing an inner membrane and laminating said inner membrane to said substrate, thereby interposing said substrate between said inner and outer membranes.

23. The method as defined in claim 20, wherein said outer membrane is formed from a material selected from the group consisting of polyvinylchloride (PVC), polyethylene, polypropylene, thermoplastic vulcanizates, thermoplastic olefin's or thermoplastic elastomers.

24. The method as defined in claim 23, wherein said outer membrane comprises polyvinylchloride (PVC).

25. The method as defined in claim 20, wherein said printing comprises applying multiple layers of ink to said second surface to simulate a three-dimensional surface texture.

26. The method as defined in claim 25, wherein each of said multiple layers of ink is a different color.

27. The method as defined in claim 20, wherein said building material is selected from the group consisting aggregate, stones, shakes, shingles, tiles and marble.

28. The method as defined in claim 27, wherein said building material is aggregate.

29. The method as defined in claim 20, wherein said printing comprises a in a gravure printing process.

30. The use of the laminate as defined in claim 1 as a decking or roofing covering.

31. The use of the laminate produced by the method of claim 20 as a decking or roofing covering.
